(19) United States
(12) Patent Application Publication
(10) Pub. No.: US 2013/0007207 A1
(43) Pub. Date: Jan. 3, 2013

(54) SYSTEMS AND METHODS FOR RETRIEVING OBJECTS FROM A PLURALITY OF NETWORK LOCATIONS

(76) Inventors: Bradley W. Dietrich, San Francisco, CA (US); Jed Putterman, San Francisco, CA (US); Daniel Putterman, San Francisco, CA (US)

(21) Appl. No.: 13/536,400

(22) Filed: Jun. 28, 2012

Related U.S. Application Data
(60) Provisional application No. 61/503,567, filed on Jun. 30, 2011.

(51) Int. Cl. G06F 15/16

(52) U.S. Cl. 709/217

(57) ABSTRACT

A system and method for retrieving objects from a plurality of network locations is disclosed. A first object may be stored at a first network location and a second object may be stored at a second network location. The first and second objects may be grouped as a bundle. A user device may transmit a request to retrieve the bundle and a central management server may retrieve the first and second objects of the bundle from the first and second network locations. The central management server may determine an address location on a wide area network for each of first and second objects and then retrieve the first and second objects from the first and second network locations from the determined address locations. The objects may then be transmitted to the user device.

### RELATED APPLICATION

This application claims the benefit, under 35 USC §119, of U.S. Provisional Application No. 61/503,567 filed on Jun. 30, 2011 and entitled “Systems and Methods for Centrally Managed Remote Access of a Device on a Network”, which is hereby incorporated by reference herein in its entirety.

### BACKGROUND

1. Field

The present disclosure is related to remote access, and more specifically towards systems and methods for retrieving objects from a plurality of network locations.

2. Art Background

Conventional online storage services may provide data storage for a user's files. For example, a user may store his or her documents, photos, music, or other files on a conventional online storage service. However, such conventional online storage services provide certain limitations and security issues. For example, conventional online storage services typically restrict the user to a limited amount of online storage space. Often all of the storage for all users is in one bulk storage array and employees of the service have access to all of the files on the array causing security concerns for users. Moreover, conventional online storage services may not allow a user to safely share his or her files on the conventional online storage service with the user's family and friends.

An alternative for a user is to store his or her files at home. For example, a user may store his or her files on a home computer or on an external hard disk drive. However, storing files on a home computer or an external hard disk drive will not allow the user to access his or her stored files when away from his or her home. For example, if the user is at the office and his or her external hard disk drive is at home, then the user will not be able to access the files on the external hard disk drive or on his or her home computer until the user returns home from the office.

Accordingly, it is highly desirable to develop systems and methods for providing access to objects (e.g., files) from a plurality of network locations. The systems and methods may allow a user to specify a bundle comprising a plurality of objects from an online service and/or a storage device and to remotely retrieve the bundle with a query.

### BRIEF DESCRIPTION OF THE DRAWINGS

The novel features of the disclosure are set forth in the appended claims. However, for purpose of explanation, several embodiments of the disclosure are set forth in the following figures.

FIG. 1 is an example network environment for centrally managed access control of a device in accordance with some embodiments.

FIG. 2 is an exemplary address space for a network environment used in some embodiments.

FIG. 3 is an example network environment for initiating a communication session from a public address and a private address.

FIG. 4 is an example network environment comprising a plurality of remote users and a plurality of routing management devices.

FIG. 5 is an example display of a hierarchical file structure of a service device that has been made accessible or available to a remote user.

FIG. 6 is an example display of printer service devices of a remote user in accordance with some embodiments.

FIG. 7 is an example display of shared printer service devices accessible or available to a remote user.

FIG. 8 is a flow diagram of a method for providing a remote user access to a service device through a central management server in accordance with some embodiments.

FIG. 9A is an example configuration for providing a logical adaptation of a high level command to service device specific commands.

FIG. 9B is an example of a translation mapping of a high level command to a service specific command.

FIG. 9C is an example of data structures for the translation of a high level command to a service specific command in accordance with some embodiments.

FIG. 10 is a flow diagram of an example method for centrally managed remote access of a printer service on a network.

FIG. 11 illustrates a flow diagram of an example method for remote authentication with a service in accordance with some embodiments.

FIG. 12 is an example block diagram of a network environment 1200 comprising a plurality of network locations storing for objects.

FIG. 13 is an example graphical user interface 1300 to group one or more objects as a bundle in accordance with some embodiments.

FIG. 14 is an example method to retrieve a bundle from one or more network locations in accordance with some embodiments.

FIG. 15 illustrates an embodiment of a computer system and network system that incorporates the centrally managed access control of a device on a network systems and methods used in some embodiments.

### DETAILED DESCRIPTION

The systems and methods disclosed herein relate to centrally managed remote access of a device on a network.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

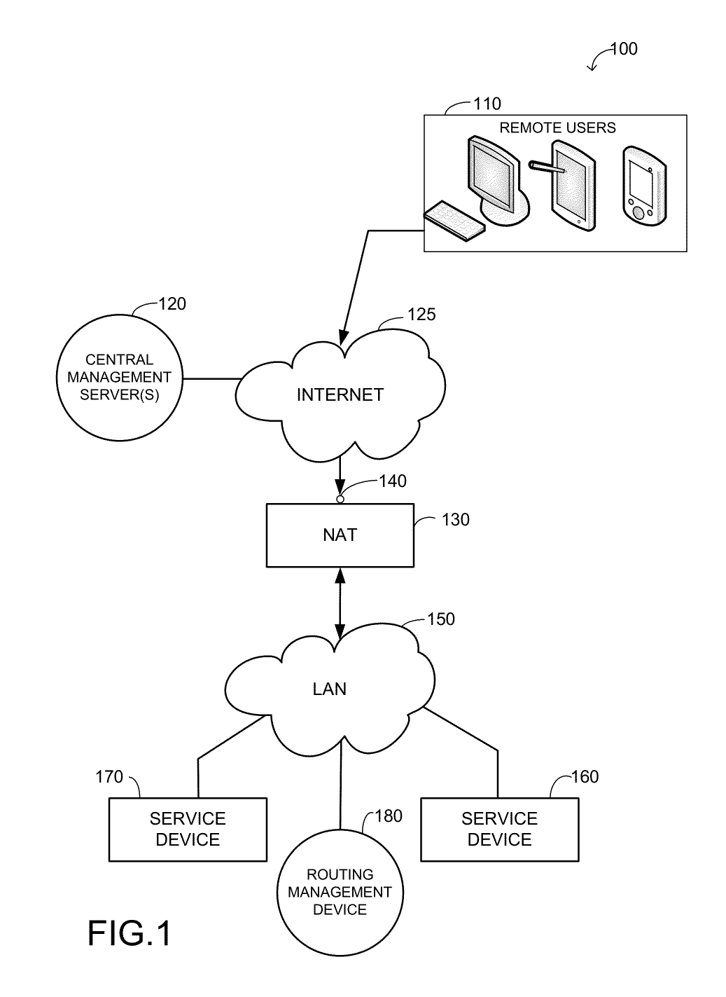

FIG. 1 is an example network environment 100 for remote access of a device on a network through central management. In general, the network environment 100 permits a remote user to access a service, such as retrieval of a file, across a wide area network 125 (e.g., the Internet). The service is associated with a device. In some embodiments, the device is coupled to a local area network (LAN) so as to access services available on the LAN. For example, the network environment 100 may provide centrally managed remote access across a wide area network (WAN) to a service device on a local area network (LAN).

As seen in FIG. 1, the network environment 100 comprises a remote user 110 (e.g., a computer system, tablet device, cell phone, or any other electronic device capable of accessing the Internet). In some embodiments, the remote user 110 may be using a device that is not directly coupled to or within a local area network to which a service device is coupled. For example, the remote user 110 may comprise a computer system at an external or remote location with relation to a local area network 150. As seen in FIG. 1, the network environment 100 may further comprise a central management server 120 and service devices 160 and 170 that may be accessible via the network 150 through the use of a routing management device 180. The remote user 110 may seek to access a service device (e.g., a hard disk drive, network printer, network camera, etc.). For example, the remote user 110 may seek to access a file stored on the service device 160 (e.g., a universal serial bus (USB) hard drive) or access a functionality or service (e.g., a camera feature or printer service) of the service device 170 (e.g., a network camera or a network printer). As such, the remote user 110 is outside of the network 150 and is seeking to access a service device 160 and/or service device 180 that is within the network 150. For example, the network 150 may comprise a private network (e.g., local area network) behind or administered by a network router.

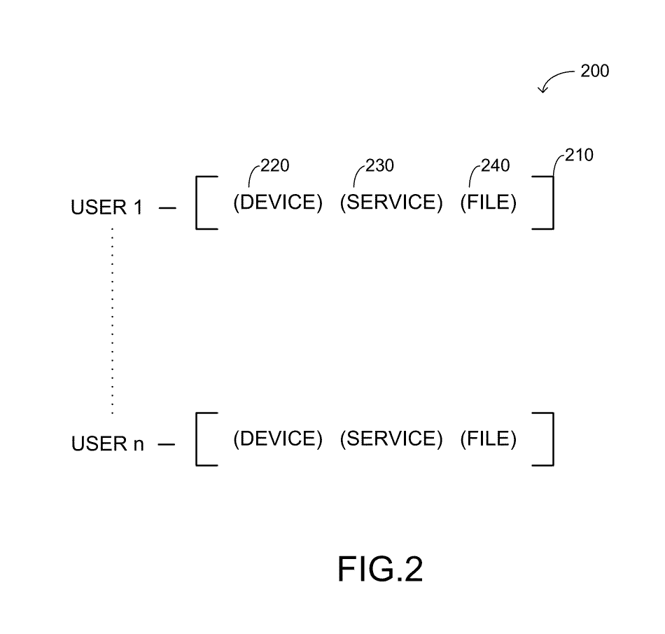

As seen in FIG. 1, the remote user 110 may initiate a communication session with a central management server 120 in order to gain access to a file or a service associated with a service device 160 and/or 170 coupled to, within, or attached to the network 150. In some embodiments, the central management server 120 may authorize or deny the remote user 110 access to a file or service associated with a service device 160 and/or service device 170 attached to the network 150. As such, the central management server 120 may determine whether the remote user 110 is authorized or unauthorized to access the file or service associated with a service device. For example, when the remote user 110 initiates a communication with the central management server 120, the communication may comprise information that includes a user credential. In some embodiments, the user credential is a username and password. In the same or alternative embodiments, the user credential is a hyperlink (e.g., a URL) or a guest user, as will be discussed in further detail below. As such, in some embodiments, the central management server 120 will associate a set of permissions to each user credential. For example, a particular username may be associated with a set of permissions that authorizes a remote user to access a subset of the service devices on the network 150 or a subset of services or a subset of files within a specific service device on the network 150. Further details with regard to permissions that may be associated with a remote user are discussed with relation to FIG. 2.

In order to access a service, the remote user 110 may transmit a user credential to the central management server 120. The remote user 110 may further transmit, to the central management server, a communication request to access a service device on the network 150. In some embodiments, the central management server 120 may further determine whether the remote user 110 is authorized to access a service or file of the service device.

In some embodiments, the routing management device 180 establishes or initiates a communication channel or session to the central management server 120. For example, the routing management device 180 may be within or coupled to the network 150 and may initiate a communication session (e.g., TCP or UDP session) over the Wide Area Network (e.g., Internet) to the central management server 120. In some embodiments, the routing management device 180 may initiate a communication session with the central management server 120 by opening a port 140 on the network address translator (NAT) 130 (e.g., a network router). Thus, communication from the routing management device 180 to the central management server 120 and communication from the central management server 120 to the routing management device 170 may be routed through the port 140 of the NAT 130. As such, port 140 is an opened port that facilitates communication between the central management server 120 and the routing management device 170. However, communication through the opened port 140 is managed by the central management server 120 through the use of the address space as discussed with relation to FIG. 2. As such, a routing management device may initiate an Internet based session (e.g., an HTTP session) with the central management server and the NAT may assign a port to the routing management device when the session is initiated.

The central management server 120 may administer data sent to and from routing management device 180. For example, the central management server 120 may receive a communication request from the remote user 110 to access a service device 160 on the network 150. The central management server 120 may authenticate the remote user 110 and determine that the remote user 110 is authorized to access the service device 160 on the network 150. As such, the central management server 120 may relay a communications request on behalf of the remote user 110 to the routing management device 180 through WAN 125. The routing management device 180 may then transmit the communication request from remote user 110 to the service device 160 through the network 150. The service device 160 may receive the communication request from the routing management device 180 and respond to the communication request. For example, the service device 160 may respond by transmitting data stored within service device 160 or allow access to the service device 160, which may then transmit a communication to the routing management device 180 over the LAN 150. In response, the routing management device 180 may transmit the communication from the service device 160 over the WAN 125 to the central management server 120. The central management server 120 may then relay or transmit the communication from the service device 160 to the remote user 110.

As such, the network environment 100 comprises a central management server 120 that controls remote access, across the WAN 125, to services or files of service devices on a LAN 150. Thus, communication between the remote user 110, across the WAN 125 and external to the network 150, and a service device internal to the network 150 is facilitated by the central management server 120. Additionally, no security changes need to be made to the NAT 130. As such, the full security of the LAN 150 may be retained.

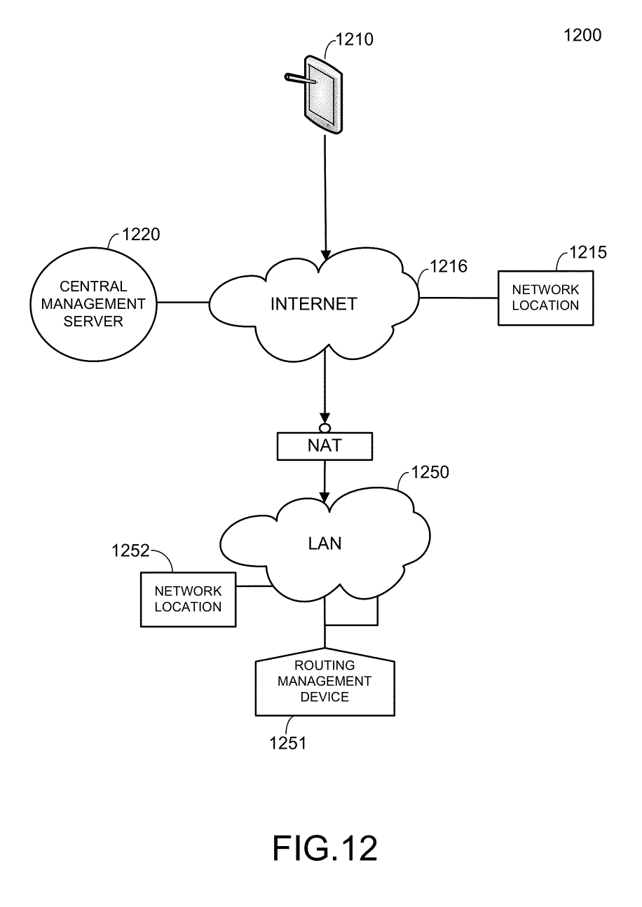

FIG. 2 is an exemplary mapping 200 of remote users to an address space 210 for a network environment used in some embodiments. In general, an address space 210 maps a remote user to a service device or to services or files within a service device on a network. As such, the address space 210 may identify a set of permissions that specify which services and files of a service device may be accessible by the corresponding remote user. In some embodiments, the mapping 200 may correspond to objects as further discussed with regard to FIGS. 12-14. For example, a user may be associated with a plurality of objects and a plurality of address spaces may be associated with a single user. As such, the address space as disclosed herein may address objects instead of users and a plurality of such address spaces may be associated with a single user.

As seen in FIG. 2, for this embodiment, the address space 210 comprises, for each remote user 1 through n, a device field 220, a service field 230, and a file field 240. In some embodiments, a plurality of address spaces 210 may be allocated to a single user and/or a single object. The address space 210 may comprise a sequence of characters and a character string of variable length may represent each of the device field 220, service field 230, and file field 240. In some embodiments, the device field 220 may identify a specific service device. In the same or alternative embodiments, the device field 220 may identify an endpoint beyond a local router or a firewall (e.g., a service device on a local area network). The device field 220 may identify a specific routing management device 180 of FIG. 1. As such, the central management server 120 may be in communication with a plurality of routing management devices where each routing management device may be uniquely identified and addressed through a different address space. For example, each routing management device may comprise a unique identification number or address. As such, the device field 220 may comprise the unique identification number or address of a specific routing management device. The service field 230 may comprise an addressable software endpoint. For example, the service field 230 may represent a software endpoint of a service device that may be further queried. In some embodiments, the service field 230 identifies a software endpoint of a service device (e.g., a file structure of a hard disk drive, camera service of a network camera, printing service of a network printer, etc.) within a local area network to which a specific routing management device is coupled or connected. For example, the routing management device 180 of FIG. 1 is coupled to or within the LAN 150. Service devices 160 and 170 are also connected to or within the LAN 150 and may be represented by a software endpoint that is associated with data, service, or functionality of the service devices 160 and 170. For example, the software endpoint of a service device may comprise a data file or folder (e.g., a hierarchical namespace view of files and folders) stored within a service device or a functionality or capability (e.g., camera, printing, client session) of the service device. As such, the service field 230 may identify an addressable software endpoint of a service device that is coupled to or within a LAN that includes a routing management device.

The file field 240 may comprise an identification of a file or a plurality of files on a service device that is coupled to the network. As such, the file field 240 may identify specific files of a service device that a remote user is authorized to access. For example, the file field 240 may identify a file or a folder or directory within a service device on the network. In some embodiments, if the file field 240 identifies a folder or a directory, then each file contained within the folder or the directory may be accessible by a remote user. As such, the file field 240 may identify specific files or folders of a service device (e.g., a hard drive device such as a USB hard drive) that may be accessed by a particular remote user. In some embodiments, the file field 240 may identify a software file that is used to control a capability or feature of a service device. For example, the file field 240 may identify a single software file if the device comprises a camera, printer, etc.

In some embodiments, the address space 210 may comprise a device field, service field, and file field. The device field may be used to identify a specific routing management device, the service field may be used to identify specific service devices that may be accessible to a remote user, and the file field may be used to identify specific files on a service device that may be accessible to a remote user. As such, a particular address space 210 may be assigned to each remote user account, user credential, or remote user 1 through n such that the address space is used to route communications or data between a remote user and a specific routing management device and to determine services and files that the remote user is authorized to access.

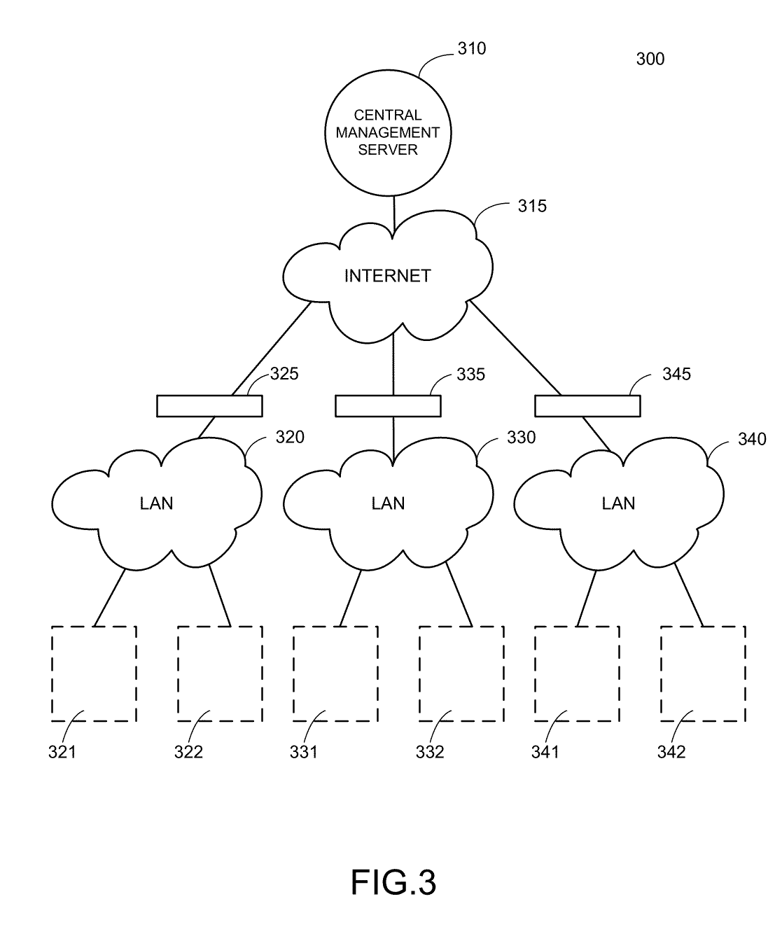

FIG. 3 is an example network environment 300 for a routing management device to initiate a communication session from a public Internet Protocol (IP) address and/or a private IP address to a central management server. In general, the routing management device, as previously described with relation to FIG. 1, may be moved to different locations that comprise different public IP addresses and/or different private IP addresses. However, a communication session between the routing management device and the central management server may be initiated or established regardless of the public IP address or private IP address of the routing management device. As such, a remote user may be able to access the routing management device or service devices within a network to which the routing management device is coupled without specifying the location (e.g., public IP address and/or the private IP address) of the routing management device. Thus, the network environment for a centrally managed remote access of a device may be considered to be independent of the location of the routing management device or service device.

As seen in FIG. 3, a network environment 300 may comprise a wide area network 315 (e.g., the Internet) and local area networks 320, 330, and 340. Each local area network 320, 330, and 340 may be associated with or coupled to a network address translator (NAT) such as a network router 325, 335, or 345 respectively. In some embodiments, each of the network address translators 325, 335, and 345 may be associated with a unique public IP address. For example, each NAT 325, 335, and 345 may provide an Internet routable address or public IP address for communication with another device (e.g., a server) over a wide area network 315 (e.g., the Internet). As such, each NAT 325, 335, and 345 may be addressable (e.g., via the network 315) by its public IP address. Moreover, each NAT 325, 335, and 345 may comprise an intermediary interface for devices (e.g., a routing management device or a service device) within or coupled to a respective local area network 320, 330, and 340. Each routing management device or service device within or coupled to the local area network 320, 330, and 340 may be associated with a private IP address within the local area network 320, 330, or 340. As such, each NAT may receive communications or data sent to the public IP address associated with the NAT and the communications may be routed or mapped to a routing management device or a service device associated with a private IP address. As such, a NAT may map private IP addresses on a local area network to a single public IP address. In some embodiments, the NAT may map Transmission Control Protocol (TCP) or User Datagram Protocol (UDP) sessions to individual private IP addresses.

For this configuration, the network address translator (e.g., a network router) comprises a public IP address for communication with devices over the Internet. Devices, such as computers, servers, network printers, network cameras, or other such hardware devices, may be connected to the NAT through a local area network. Each of the devices of the local area network may comprise a private IP address. Thus, multiple devices on a local area network may share a single public IP address through the NAT.

As seen in the example of FIG. 3, the network environment 300 comprises a plurality of local area networks 320, 330, and 340. The local area network 320 is associated with the NAT 325, the local area network is associated with the NAT 335, and the local area network 340 is associated with a NAT 345. Each local area network may be connected to one or multiple devices. As previously described, each device connected to the local area network may comprise an individual private IP address while a NAT for each local area network may comprise a public IP address. For example, the local area network 320 may comprise private IP addresses 321 and 322, the local area network 330 may comprise private IP addresses 331 and 332, and the local area network 340 may comprise private IP addresses 341 and 342. As such, the routing management device, as previously described with relation to FIG. 1, may be associated with any of the private IP addresses 321, 322, 331, 332, 341, and 342. If the routing management device is connected to the local area network 320, then the routing management device may comprise either private IP address 321 or 322. As such, if the central management server 310 transmits a communication to the routing management device when it is associated with private IP address 321, the communication may be transmitted to the NAT 320 at its associated public IP address and the NAT may map and route the communication to the routing management device at its current private IP address.

In some embodiments, the routing management device may broadcast its associated IP address to the central management server. The broadcast may comprise initiating an outbound communication session from the routing management device to the central management server. The communication session may comprise information describing a unique identifier or unique address associated with the routing management device. For example, as previously described, each routing management device may comprise a unique identifier or unique address such that when an outbound communication is initiated or established from the routing management device to the central management server, the unique identification or unique address of the routing management device may be used by the central management server to validate or identify the specific routing management device at its new location (e.g., a public IP address). Thus, the routing management device may initiate a communication session with the central management server and the routing management device may communicate with the central management server regardless of its public IP address or private IP address.

As such, the routing management device may be within or coupled to local area network 320 with a NAT 325. For example, the routing management device may be associated with or comprise private IP address 321. The routing management device may initiate an outbound communication session to the central management server. The outbound communication may comprise the unique identification or unique address of the routing management device and may be initiated through opening a port of the NAT 325 (e.g., a router, firewall, etc.). Upon receiving the outbound communication session from the routing management device, the central management server may validate the routing management device by using the unique identification or unique address or cryptographic key. After validating the routing management device, the central management sever may effectuate communications with the routing management device. For example, the central management server may transmit a communication or data to the opened port of the NAT associated with the public IP address of the received outbound communication of the routing management device. As such, data may be transmitted to an opened port at a public IP address associated with the NAT 325 and the data may be mapped or routed back to the routing management device at its private IP address by the NAT 325. Thus, the central management server may identify and communicate with the routing management device from any public IP address and any private IP address after the routing management device has initiated the communication session to the central management server.

In some embodiments, the routing management device may initiate an outbound communication session to the central management server at any time when the routing management device is assigned a new public IP address or a new private IP address. In some embodiments, the routing management device may periodically initiate the outbound communication session to the central management server. The routing management device may comprise software or hardware instructions to initiate the outbound communication to the central management server. In some embodiments, the instructions may specify a specific address (e.g., the address of the central management server) to initiate the communication session.

In some embodiments, each routing management device comprises a unique identification. In some embodiments, when the routing management device is assigned a new public IP address and/or a new private IP address, the routing management device initiates an outbound communication session to the central management server. The outbound communication session (e.g., TCP or UDP) may comprise opening a port on a NAT (e.g., a router, firewall, etc.) and transmitting the communication or data to the central management server. For these embodiments, the communication or data comprises the unique identifier for the routing management device. For this example, the central management server receives a communication session or data from an identified routing management device at a particular public IP address through a specific port on a NAT associated with the public IP address. As such, the central management server may track the location (e.g., public IP address location and associated port) of a specific routing management device. If a remote user wishes to access the routing management device or a service device associated with the routing management device, then the remote user may access the central management server, which in turn, accesses the routing management device or service device after the routing management device has initiated the communication session.

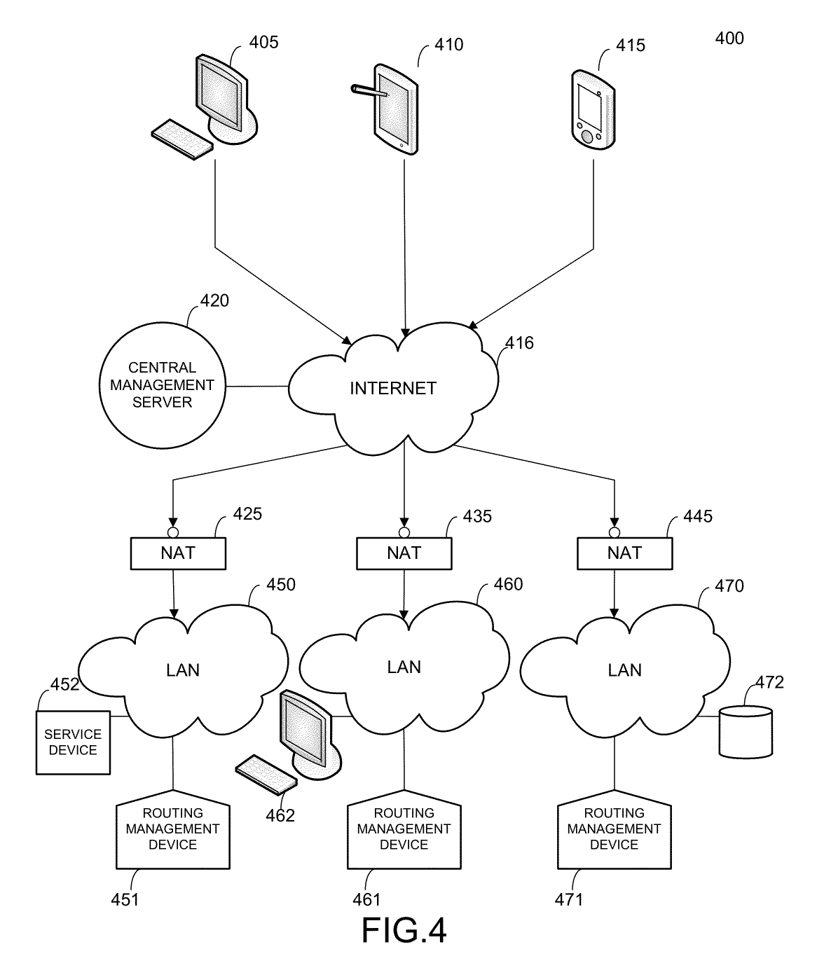

FIG. 4 is an example network environment comprising a plurality of remote users and a plurality of routing management devices. In general, a central management server may manage requests from a plurality of remote users and manage remote access to a plurality of routing management devices where each routing management device may be comprised within or connected to a different local area network.

As seen in FIG. 4, a central management server 420 may receive requests from remote users 405, 410, and 415 (e.g., a computer system, tablet device, cell phone, or any electronic device capable of accessing the network 416) across a wide area network 416 (e.g., the Internet). The central management server 420 may further have established a communication session with routing management devices 451, 461, and 471. For example, each of the routing management devices 451, 461, and 471 may have initiated a communication session with the central management server 420, as previously described with relation to FIG. 3. In some embodiments, each routing management device 451, 461, and 471 is associated with a different local area network 450, 460, or 470 such that each local area network is behind a different NAT 425, 435, or 445. As such, a wide area network (e.g., the Internet) may connect the central management server to the NATs 425, 435, and 445. Each NAT 425, 435, and 445 may comprise a router for forwarding data received from the central management server over the wide area network to a location within a private network administered by the NAT (e.g., a local area network). In some embodiments, each of the routing management devices 451, 461, and 471 may be associated with a different public IP address as well as a unique identification or unique address for identifying each routing management device.

In some embodiments, the central management sever 420 may be notified of the availability of routing management devices 451, 461, and 471 and the service devices associated with each of the routing management devices. For example, service device 462 may comprise a network printer, service device 472 may comprise a hard disk drive, and service device 452 may comprise an API for a web service and the availability of each such service device through a routing management device may be communicated to the central management server. For example, the routing management device may comprise account information of a website such that the routing management device may connect to an external website (e.g., a web server external to the network associated with the routing management device). As such, in some embodiments, a remote user may access a routing management device for the purposes of establishing a connection with an external website, as discussed in further detail below. Moreover, the routing management device may initiate a session with an external server (e.g., creating a user session with another application).

In some embodiments, each remote user 405, 410, and 415 may be associated with a different address space. For example, remote user 405 may request to access a file on the service device 472 (e.g., a hard disk drive) associated with routing management device 471. The remote user 405 may request access by clicking on a link (e.g., a uniform resource locator (URL)) that has been associated with a particular address space that specifies a device (e.g., routing management device 471), a service (e.g., service device 472), and a file (e.g., a file on the service device 472). As such, a URL link may be created and associated with an address space. In some embodiments, an address space may be associated with a shared account (e.g., a guest account) that may be used by a plurality of remote users.

In some embodiments, each of the routing management devices 451, 461, and 471 may initiate a communication session with the central management server 420. For example, the routing management device 461 may initiate a communication session with the central management server 420 by transmitting a communication or data to the central management server. In some embodiments, the transmission of communication or data from the routing management device 461 to the central management server 420 may comprise the NAT 435 opening a port. As such, the central management server 420 may communicate with the routing management device 461 through the opened port on the NAT 435 and may control communication or data traffic through the opened port. The remote user 410 may seek to access a file on a service device 462 that comprises a file structure (e.g., the service device 462 is a hard disk drive). The remote user 410 may transmit a communication to the central management server 420 requesting access to the service device 462. In some embodiments, the communication from the remote user 410 may comprise user account or credential information that associates the remote user 410 to a particular address space. The central management server 420 determines if the remote user 410 has permission to access the service device 462 by using the address space associated with the remote user 410. For example, the address space 410 may specify a routing management device associated with the service device that the remote user seeks to access. As such, the central management server 420 may relay the communication from the remote user 410 to the routing management device 461. Although the previously described example comprises a remote user seeking to access a file on the service device 462, in some embodiments, the remote user may use the systems and methods disclosed herein to provide a file to the service device 462. As such, in some embodiments, a remote user may access a service device through the central management server for the purposes of providing data for storage on the service device 462.

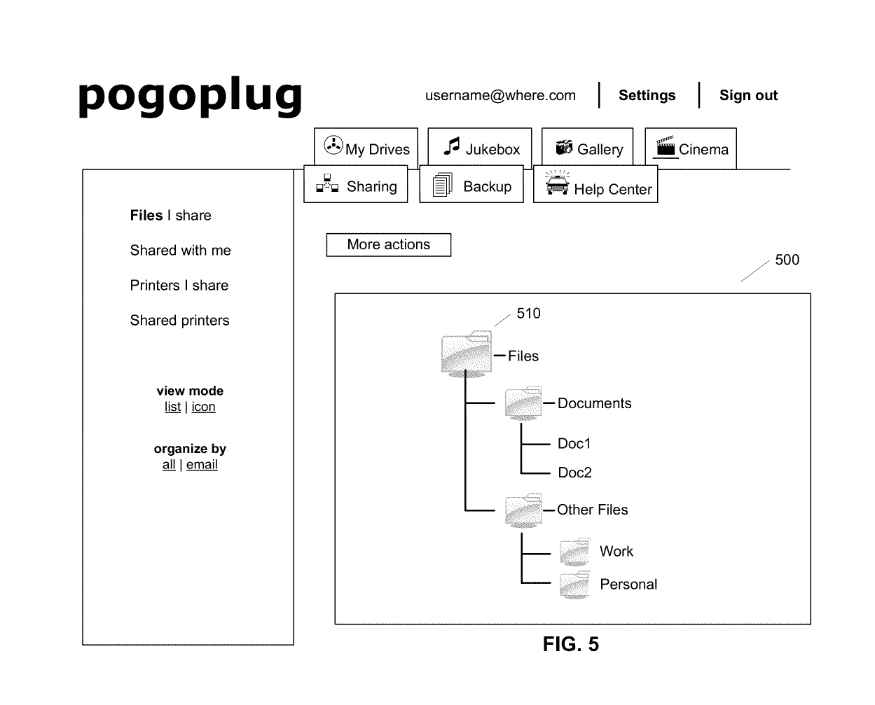

FIG. 5 is an example display 500 of a hierarchical file structure of a service device that has been made accessible or available to a remote user. In general, the display 500 may display one or more files or folders of a hierarchical structure of at least one service device that may be accessed by a remote user. As seen in FIG. 5, a hierarchical file structure 510 may comprise folders and files arranged in an organized file structure. The hierarchical file structure 510 may correspond to files and folders of a storage service device (e.g., a USB hard disk drive). As such, an authorized remote user may navigate the hierarchical file structure 510 and access any files or folders of the hierarchical file structure 510 that are stored on the corresponding storage device that the remote user has been authorized to access.

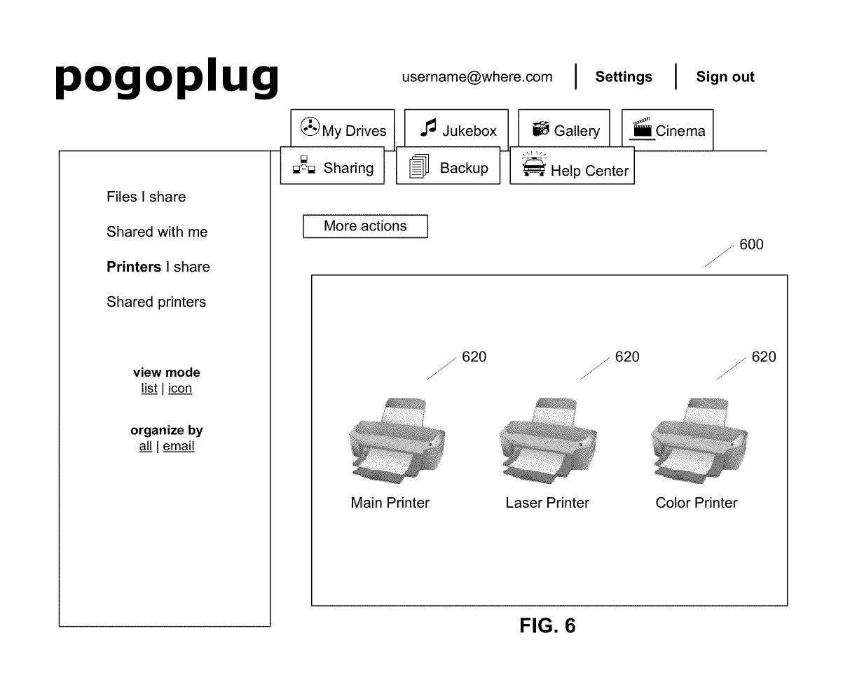

FIG. 6 is an example display 600 of printer service devices of a remote user. In general, the display 600 may display printer service devices that are available or accessible to the remote user from the remote user's network. For example, a remote user's network (e.g., the remote user's home network) may comprise a “Main Printer” service device 620, “Laser Printer” service device 630, and “Color Printer” service device 640. As such, the remote user's network may comprise a routing management device and printer service devices 620, 630, and 640 coupled to or within the remote user's network. Thus, the display 600 may present to the remote user the printer service devices coupled to or within the remote user's network.

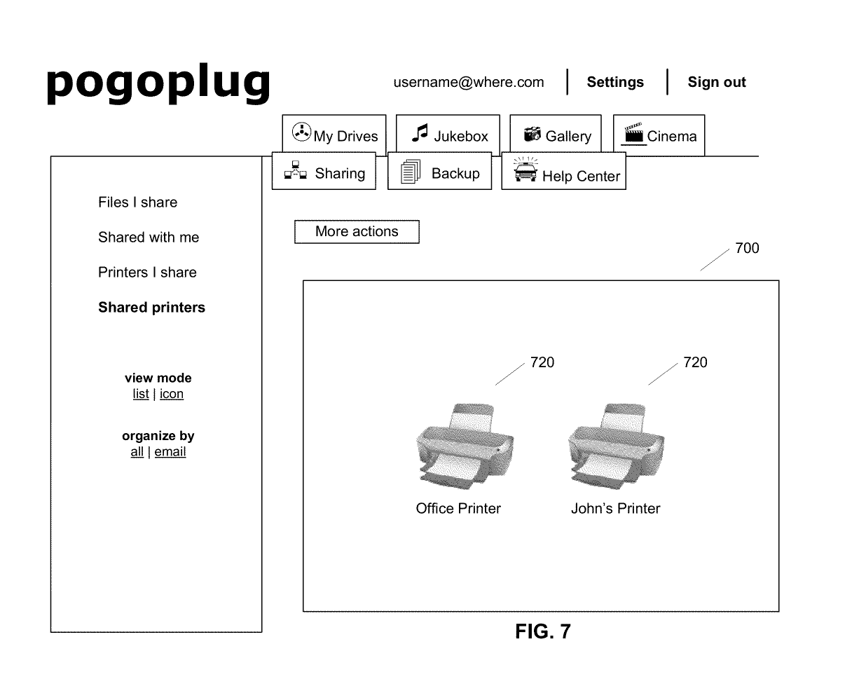

FIG. 7 is an example display 700 of shared printer service devices accessible or available to a remote user. For example, the display 700 may present to a remote user other printer service devices that have been shared with the remote user by other users. For example, the display 700 may present an “Office Printer” service device 710 and a “John's Printer” service device 720. Each of the printer service devices 710 and 720 may be within or coupled to different networks. For example, “Office Printer” service device 710 may be coupled to or within a local area network of an office and “John's Printer” service device 720 may be coupled to or within a local area network of an acquaintance of the remote user. As such, the remote user may be presented with a display of shared printer service devices that the remote user may access.

The example displays 500, 600, and 700 may be presented or displayed to a remote user after the remote user has been authorized or authenticated by a central management server. For example, the displays may be presented after the remote user has provided a user credential (e.g., a username and password, clicked on a shared URL link, etc.).

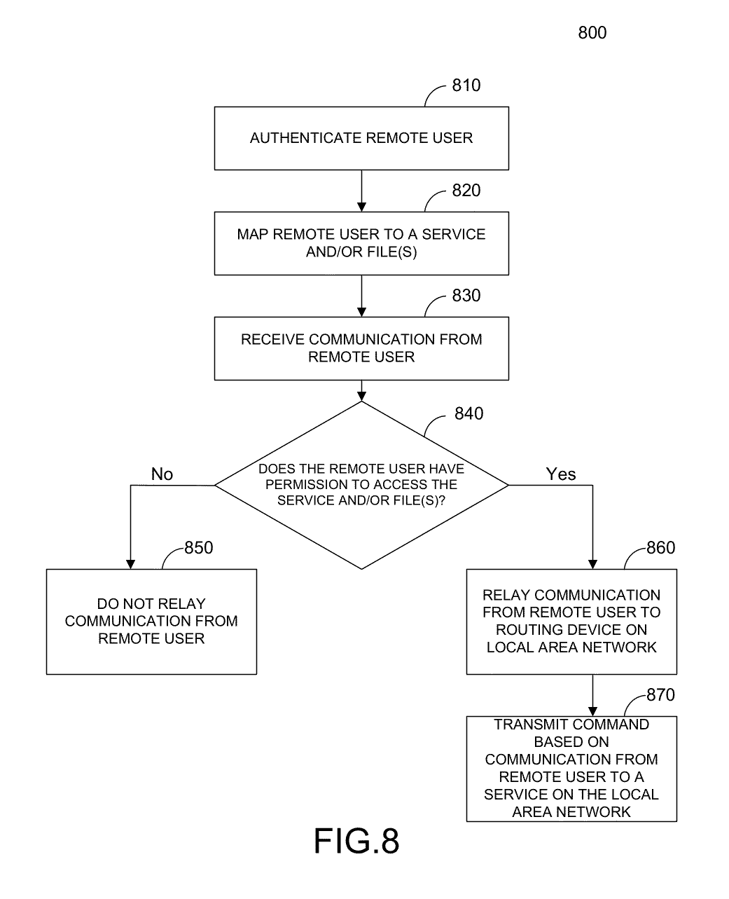

FIG. 8 is an example flow diagram of a method 800 for providing a remote user access to a service device through a central management server. In general, the method 800 comprises one embodiment of a process to relay a communication (e.g., data, request, etc.) from a remote user to a service device on a local area network if the remote user has the permission to access the service device.

As seen in FIG. 8, at block 810, a remote user may be authenticated. In some embodiments, the central management server as described with relation to FIG. 1 may authenticate the remote user. For example, the central management server may authenticate the remote user based on a username and password provided by the remote user or from a link that the remote user has accessed (e.g., a specific URL). At block 820, the remote user is mapped to a routing management device, service, and/or files. For example, each authorized remote user may be associated with at least one address space (e.g., address space 210 of FIG. 2). In some embodiments, an authorized remote user may be associated with a plurality of address spaces. As such, each authorized remote user is mapped to at least one address space that comprises permissions to access a service and/or a file of a service device associated with a particular routing management device. At block 830, a communication or data is received from the authorized remote user. In some embodiments, the communication may comprise a request to access a service device associated with a routing management device. For example, the communication may comprise a request to access a printing service of a network printer on a local area network with a routing management device. At block 840, a determination is made whether the authorized remote user has permission to access the service and/or files of the service device associated with the particular routing management device. For example, the determination may be made by analyzing the address space that has been assigned or mapped to the authorized remote user. If the authorized remote user does not have permission to access the service and/or files of the service device associated with the particular routing management device, then, at block 850, the communication from the authorized remote user may not be relayed from the central management server to the routing management device. However, if the authorized remote user does have permission to access the service and/or files of the service device associated with the particular routing management device, then, at block 860, the communication from the authorized remote user may be relayed from the central management server to the routing management device on a particular local area network. For example, the communication may be relayed to a port at a public IP address of a NAT (e.g., the port at the public IP address corresponding to a session established with the routing management device) and the NAT may map the communication to the routing management device with a private IP address on the local area network associated with the NAT that established an initial outbound communication with the central management server. At block 870, the routing management device may transmit a command to the service device corresponding to the communication from the authorized remote user, as will be discussed in more detail below. In some embodiments, the routing management device may transmit the command to the service device over the local area network (e.g., from a first private IP address of the private network to a second private IP address of the private network).

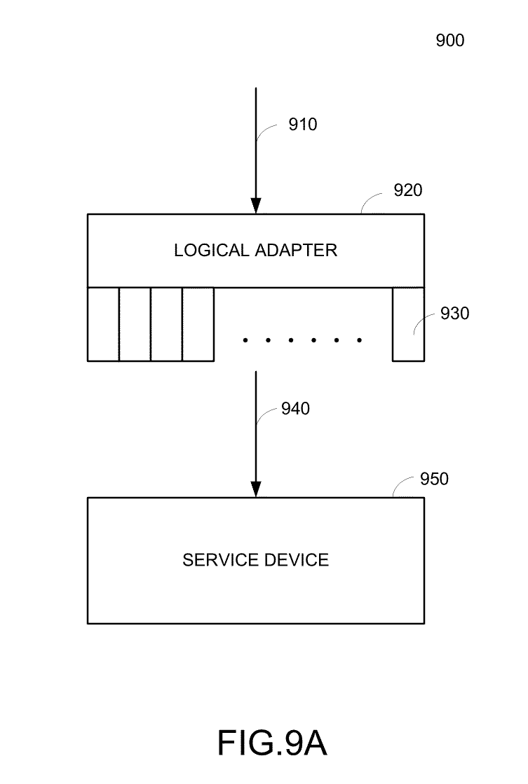

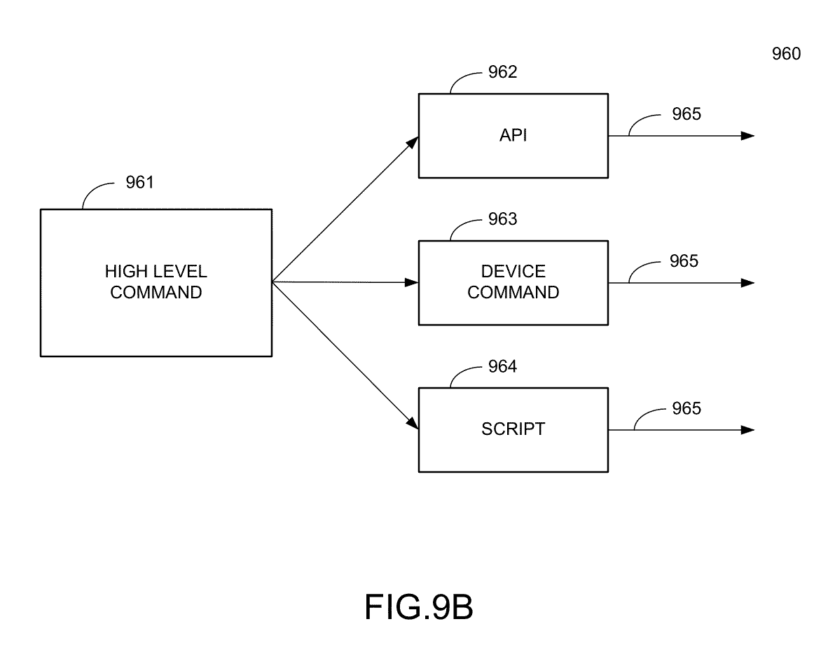

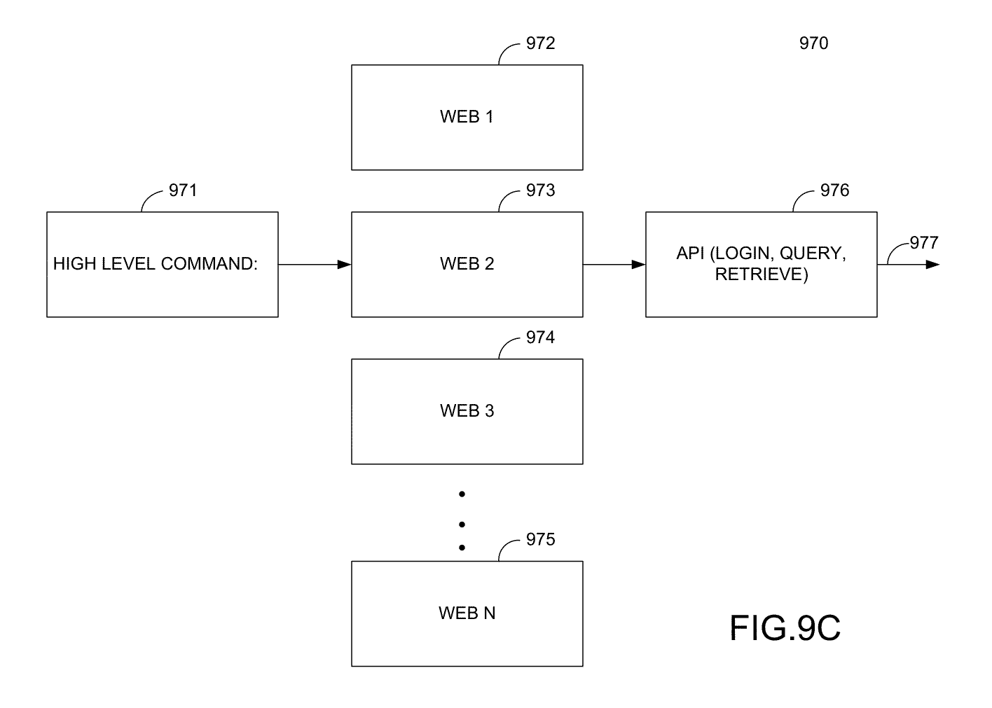

FIG. 9A is an example configuration 900 for providing a logical adaptation of a high level command to service device specific commands. In general, the configuration 900 receives a high level command, applies a logical adaptation to the high level command, and transmits the resulting service device specific command to a service device.

As seen in FIG. 9A, the configuration 900 comprises a logical adapter 920 with logical adaptation blocks 930. In some embodiments, the logical adapter 920 is part of a routing management device. For example, the logical adapter 920 may comprise software running on a routing management device. The logical adapter 920 may receive a high level command 910. In some embodiments, the high level command 910 may be comprised within a Hypertext Transfer Protocol (HTTP) Web service (e.g., a message of Simple Object Access Protocol (SOAP) or JavaScript Object Notation (JSON) format). In general, the high level command 910 may be translated or adapted by the logical adapter 920 by using a specific logical adaptation block 930. As such, the high level command 910 may be translated or adapted to a service device specific command 940. For example, each logical adaptation block 930 may comprise a set of rules for translating or adapting the high level command 910 to a service device specific command 940. In some embodiments, the service device specific command 940 may be for a storage device (e.g., a USB hard disk drive), network printer, network camera, an application programming interface (API) for a web service (e.g., an online storage web service or a website providing a service or data). As such, the service device specific command 940 may be transmitted to a service device 950.

FIG. 9B is an example of a translation mapping 960 of a high level command to a service specific command. In general, the translation mapping 960 may translate a high level command 960 (e.g., a command from a remote user relayed to the routing management device by the central management server) to a service specific command. For example, the routing management device may receive a high level command 961. The routing management device may map the high level command 961 to commands associated with a particular API 962 or a translation script 964. In some embodiments, the high level command 961 may be directly mapped to a device specific command 963. As such, the routing management device may map a received high level command to an API, script, or any other software code that may translate a high level command to a service specific (e.g., a specific service device or an API of a website) command 965. After mapping the high level command to an API, script, or other software code, the service specific command 965 may be transmitted to the corresponding service.

FIG. 9C is an example of data structures 970 for the translation of a high level command to a service specific command. As seen in FIG. 9C, a high level command 971 may be received by a routing management device. For example, the high level command 971 may comprise a command to retrieve files (e.g., [Retrieve(Files)(Website2)]) from a user account associated with an online website. The routing management device may analyze the high level command and map the high level command to a particular service (e.g., a specific website). For example, the routing management device may comprise a plurality of website API translation modules 972 through 975 for translating the high level command 971 to a command that may be executed at the API of a specific website. As such, each translation module 972 through 975 may implement a translation of the high level command 971 into a command that may be used to interact with an API of a service device or website. For example, the high level command 971 may be identified with the ‘website2’ translation module 973. The high level command may then be translated to API specific commands 976 such that translated commands may be used to interact with a website associated with the translation module. For example, a high level command to retrieve files from an online website (e.g., [Retrieve(Files)(Website2)]) may be translated by the translation module 976 to one or more API specific commands (e.g., Login, Query, and Retrieve). As such, the translated commands 977 may be used by the routing management device to transmit translated commands to the website service when initiating a session with the website.

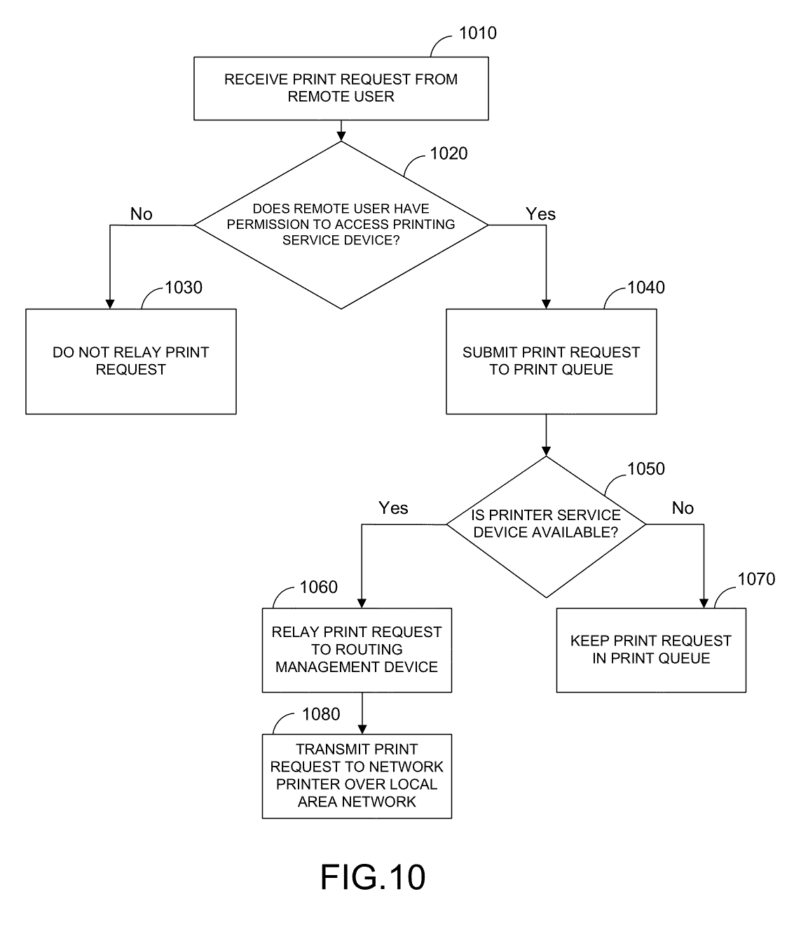

FIG. 10 is a flow diagram of an example method 1000 for centrally managed remote access of a printer service on a network. In general, the method 1000 receives a print request from a remote user and transmits the print request to a printer on a network.

As seen in FIG. 10, at block 1010, a print request may be received from a remote user.

In some embodiments, the central management server may receive the print request. In the same or alternative embodiments, the print request may be received after the remote user has been authenticated. For example, the remote user may submit a username and/or password to the central management server to verify a remote user account.

In some embodiments, the print request may originate from a remote user using a computer system. For example, the computer system used by the remote user may comprise software such as device drivers (e.g., a device driver for a printer). The device drivers may allow an application on the computer system to interact with a hardware device by translating routine or function calls from an application running on the computer system to device specific commands. As such, if the remote user using the computer system makes a print request, the computer system or applications on the computer system may invoke a routine in the printer device driver and translate the invoked routine to at least one device specific command. In some embodiments, the print request may be translated by the printer device drivers into device specific commands and such device specific commands may be bundled into a high level HTTP protocol for transmission over a network (e.g., the Internet) from the computer system to the central management server. As such, a high level HTTP protocol comprising a print command (e.g., the command translated by the printer device drivers) may be transmitted over a network (e.g., a wide area network such as the Internet) from a computer system to the central management server.

As seen in FIG. 10, at block 1020, a determination is made whether the remote user has permission to access a printer service device. In some embodiments, the permissions for the remote user may be defined by an address space 210 as previously discussed with relation to FIG. 2. If the remote user does not have permission to access the printer service device, then at block 1030, the print request received from the remote user may be rejected and the remote user may be informed that the account associated with the remote user does not have permission to access the printer service device. If the remote user does have permission to access the printer service device, then at block 1040, the print request received from the remote user may be submitted to a print request queue. In some embodiments, the central management server may comprise the print request queue for storing at least one print request. At block 1050, a determination is made whether the printer service device is available. In some embodiments, the printer service device may be available if the printer service device is operating and connected to a local area network that comprises at least one routing management device. As such, if the printer service device is offline or if the routing management device is offline, then the printer service device may not be available. Thus, if the printer service device is not available, then, at block 1070, the print request may be retained in the print request queue. In some embodiments, the print request may remain in the print request queue until the printer service device is available. At block 1060, the print request from the remote user may be relayed to the routing management device if the printer service device is available. In some embodiments, the routing management device may be associated with or connected to a local area network, as previously described with relation to FIG. 1. At block 1080, the print request is transmitted from the routing management device to the printer service device (e.g., a network printer on the same local area network as the routing management device). Although the above example discusses printer services, this queue can be seen to generically apply to other specific service types. As such, a request queue may be used for any service of any service device.

As such, a service device may comprise a network printer. In some embodiments, the network printer is within the same local area network as the routing management device. The routing management device may discover or identify the network printer on the local area network. For example, a network discovery protocol (e.g., Bonjour) may be used by the routing management device to discover the presence of the network printer on the local area network. The routing management device may probe or analyze the data included in the network discovery protocol to receive information about the network printer (e.g., the type of network printer). Next, the routing management device may notify (e.g., transmit a communication to) the central management server of the identified printer service. As such, the central management server may update a record of services or service devices associated with each routing management device. For example, a record of services or service devices associated with a unique address, identification, or cryptographic key of a routing management device may be maintained by the central management server. If a remote user submits a print request for the network printer, then a high level command may be transmitted to the central management server and then relayed to the routing management device. For example, the high level command may comprise Queue(srcdeviceid=<routing management device identification>, srcefileid<the file that the remote user is seeking to print>, destdeviceid=<routing management device identification>, dstserviceid=<printer service identification>). As such, once the network printer is online and ready to receive the print request from the remote user, the source document (e.g., the file that the remote user is seeking to print) may be transferred from the routing management device to the network printer over the local area network. In some embodiments, the source document may be converted to another file format (e.g., Portable Document Format (PDF)). The details of the printer as analyzed from the network discovery protocol may be used to identify how to translate the source document to the network printer specific format. Next, the network printer specific formatted source document may be submitted to the network printer via the local area network TCP connections. The results of the request from the remote user may be messaged back to the remote user (e.g., whether the request to use the printer service of the network printer was successful or not).

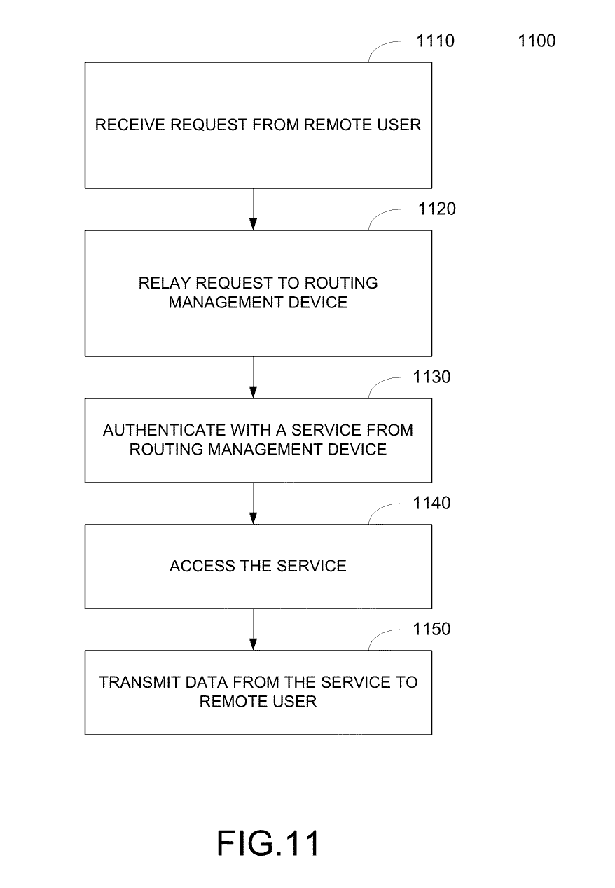

FIG. 11 is a flow diagram of a method 1100 for remote authentication with a service in accordance with some embodiments. In general, the method 1100 receives a request from a remote user and accesses a service (e.g., a service device or a service provided by an external server) after providing authentication information to the service.

As seen in FIG. 11, at block 1110, a central management server may receive a request from a remote user. In some embodiments, the request may comprise a communication or data request for a service or data associated with a service device connected to a local area network (as previously described) or an external server (e.g., a website). At block 1120, the request may be relayed from the central management server to a routing management device on a local area network. At block 1130, the routing management device may provide authentication information (e.g., a username and password) for a service. In some embodiments, the authentication information may be stored in the routing management device. In the same or alternative embodiments, the request from the remote user may comprise the authentication information. As such, the routing management device may use the authentication information when establishing a connection or session with a service. In some embodiments, the authentication information may be used to establish a connection or create a session with a service device coupled to or within the same local area network of the routing management device. For example, the service may comprise accessing a service device such as a network server. In the same or alternative embodiments, the routing management device may use the authentication information to establish a connection or create a session with a service associated with an external server (e.g., a website server not within or coupled to the local area network). For example, the routing management device may create a session with a server to retrieve information of an online account (e.g., a website or online account associated with social networking, online photo storage, cloud storage, document storage, etc.) or any other service that may require a level of authentication (e.g., a username or password). In some embodiments, the routing management device may communicate with an API of a website or online account to retrieve data from the online account or website. As such, the routing management device may retrieve data from an online account by using authentication information to establish a session with an external server.

As such, the remote user may transmit a request to access data from an account on a website or web server. The request may be transmitted to the central management server and relayed to the routing management device. In some embodiments, the routing management device may then initiate a communication session with the website (e.g., an external web server) and enter account authentication information (e.g., a username and password) to access data from the website account. The data may be retrieved from the website by the routing management device and then relayed back to the remote user through the central management server.

Thus, the above recited systems and methods may provide centrally managed remote access of a service device. For example, the service device may comprise a USB mass storage device (e.g., a USB hard disk drive). In some embodiments, the USB mass storage device may be coupled to the routing management device via a USB bus. The coupling of the USB mass storage device to the routing management device may result in the routing management device receiving a service device event. In some embodiments, a service device event may be a software notification or alert that a service device has been coupled to the routing management device. For example, the service device event may comprise a USB mass storage device being coupled to a USB bus of a routing management device. In response to the service device event, the routing management device may probe a block level of the coupled USB mass storage device for a file system format. The routing management device may then notify (e.g., transmit a communication to) the central management server of the service device associated with the service device event. As such, the central management server is made aware and may keep a record of the service devices that are coupled to each routing management device. The routing management device may receive high level commands from a remote user as determined by the central management server. Such high level commands may be translated by the routing management device to device specific commands for using the USB mass storage device. For example, the routing management device may determine a specific block in the USB mass storage device that corresponds to a root directory. The routing management device may issue a block read command to retrieve the block corresponding to the root directory. The routing management device may parse the data of the retrieved block into directory entry structures. In some embodiments, files in the directory may be mapped to a unique file identification within the USB mass storage device. For example, the file identification may be recorded into a database stored and/or created on the USB mass storage device for subsequent file retrieval by using the file identification. In some embodiments, the database may be used for implementing search commands. For example, a remote user may transmit a request to search for at least one file that matches the remote user's search criteria. Such a request may comprise a high level command of Search(deviceID=<routing management device identification>, serviced=<service device identification>, criteria=<Search Criteria>). The routing management device may receive the high level command and use the database created and maintained by the routing management device to implement the translation between the remote user's search high level command and files within the USB mass storage device.

FIG. 12 is an example block diagram of a network environment 1200 comprising a plurality of network locations storing for objects. In general, the network locations may each store one or more objects (e.g., files) such that a remote user may access the one or more objects by using the central management server. In some embodiments, objects from one or more of the network locations may be grouped or bundled together to create a bundle. A remote user may request the bundle and the routing management device and/or central management server (as previously discussed) may retrieve the objects from the one or more network locations and transmit the objects corresponding to the bundle to the remote user.

As shown in FIG. 12, a remote user 1210 (e.g., corresponding to the remote users 110 and/or remote user 410) may transmit instructions or commands to the central management server 1220 (e.g., corresponding to central management server 120, 310, and/or 420) to create a bundle comprising a plurality of objects from one or more network locations. For example, a first object may be stored at a first network location 1215 and a second object may be stored at a second network location 1252. In some embodiments, the network locations may be a service device, computer, mobile device, hard drive, or other device capable of storing objects and/or files (e.g., corresponding to service device 452, 462, and/or 472). In some embodiments, the network location may correspond to a storage device coupled to the routing management device 1251 In the same or alternative embodiments, a network location may be a third party commercial service. For example, the network location may be a website or online service (e.g., a service outside of the local area network 1250 to which the routing management device 1251 is coupled to). In some embodiments, such a website or online service may be a social media network, cloud storage service, or any other website or online service capable of storing files.

As such, a first network location may store at least one object (e.g., a file) and a second network location may store at least one object. A remote user 1210 (e.g., a user device) may transmit instructions and/or commands (e.g., to a central management server 1220) to group one or more objects from the first network location 1252 with one or more objections from the second network location 1215 to create a bundle. The central management server 1220 may receive a request to retrieve the bundle and, as such, the central management server 1220 may retrieve the objects corresponding to the bundle. For example, the central management server 1220 may determine a network address location on a wide area network (e.g., Internet 1216) of each object of the bundle. As such, the central management server 1220 may query and/or retrieve the objects from each of the network locations storing objects corresponding to the bundle. Next, the central management server 1220 may transmit the objects corresponding to the bundle to the user device requesting the bundle.

In some embodiments, the user device may be a third party user. For example, as previously discussed, permissions may be enabled for allowing users to access files (e.g., objects). As such, a user device that does not own the content of the objects of the bundle may request the bundle. Thus, the central management server may receive a request from a third party user to access the bundle. Moreover, the central management server may determine if the third party user (e.g., a third party user device) is authorized or has permission to access the bundle. If the third party user is authorized to access the bundle, then the central management server may transmit the objects of the bundle (e.g., from one or more network locations) to the third party user. Moreover, third party user devices may access the bundle by way of a link and/or email as previously discussed with remote users accessing files.

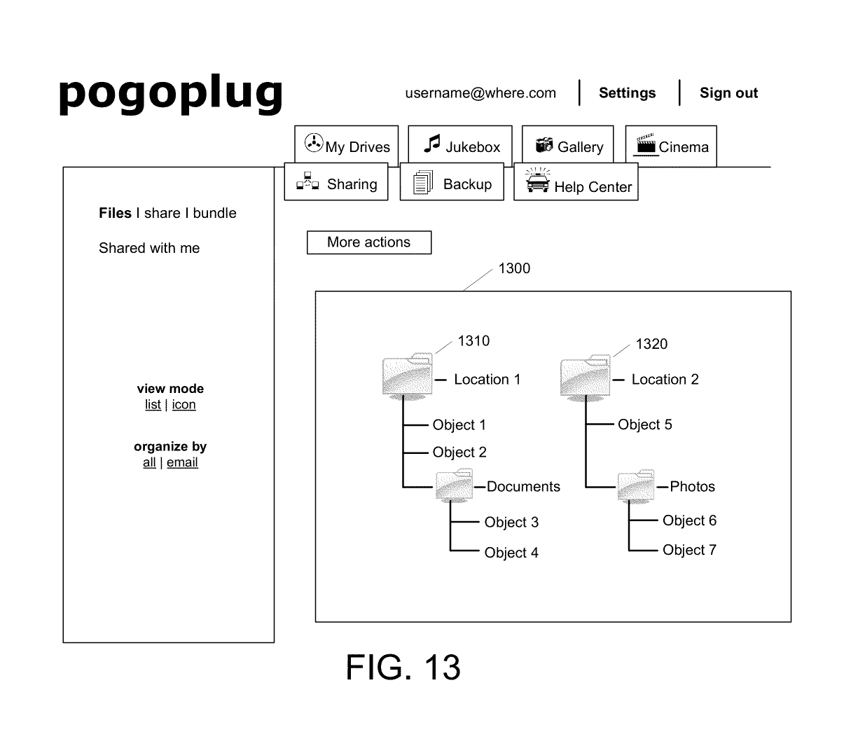

FIG. 13 is an example graphical user interface 1300 to group one or more objects as a bundle. In general, the graphical user interface 1300 may be presented to a user so that the user may group one or more objects (e.g., files) from a first network location (e.g., network location 1215) with one or more objects from a second network location (e.g., network location 1252) to create a bundle such that when the bundle is requested (e.g., from the user or a third party user), the one or more objects from the first network location and the one or more objects from the second network location may be transmitted to the requesting user.

As shown in FIG. 13, the graphical user interface 1300 may display objects from one or more network locations. In some embodiments, the graphical user interface 1300 may be generated by the central management server (e.g., central management server 1220) and/or routing management device (e.g., routing management device 1251). The graphical user interface 1300 may display network locations (e.g., service devices, websites, online services, etc.) associated with the routing management device. For example, the graphical user interface 1300 may display a first network location 1310 and a second network location 1320. Each of the network locations 1310 and 1320 may be associated with a different network address and/or location. In some embodiments, each of the network locations 1310 and 1320 may store one or more objects. The graphical user interface 1300 may be used to group one or more objects into a bundle. For example, a plurality of objects from the first network location may be grouped into a bundle. In another example, one or more objects from the first network location may be grouped with one or more objects from the second network location to create a bundle. In some embodiments, a folder may be grouped into a bundle and the files under the hierarchical structure of the folder may be grouped into the bundle (e.g., as previously discussed).

As such, the grouping of objects from one or more network locations as a bundle may be accomplished through a graphical user interface that displays icons corresponding to objects stored on the network locations. A user may use the graphical user interface to bundle together at least two objects. In some embodiments, a user may submit a query (e.g., through the graphical user interface 1300) that comprises at least one parameter to location at least two objects. For example, the query input may correspond to a request to receive a type of object. For example, the query may correspond to retrieve photos associated with the network locations. As such, in response to the query, the routing management device and/or central management server may search and/or query the network locations to locate objects that meet and/or satisfy the query submitted by the user and create a bundle that comprises objects that satisfy and/or meet conditions of the query. In some embodiments, the query may comprise parameters specifying a time range such as a date associated with the objects such as a time when the object was created or when the object was stored onto a network location. For example, the query may be a query for photos from a particular week. In response to the query, the central management server may retrieve all photos from the particular week on all of the specified network locations.

In some embodiments, the grouping of objects into a bundle may comprise grouping objects from a website or online service into a bundle. For example, an application program interface (API) may be exposed (e.g., as previously discussed with regard to FIG. 9C) and an identification in the API to at least two objects may be received. In response, a bundle may be created such that the bundle comprises the objects from the online service associated with the API. Furthermore, in some embodiments, the graphical user interface 1300 may be used to receive an input to specify access control and/or permissions to bundles such that the bundle may be shared with third party users, as previously discussed. In some embodiments, the location of the website or online service may be specified by a user to the central management server.

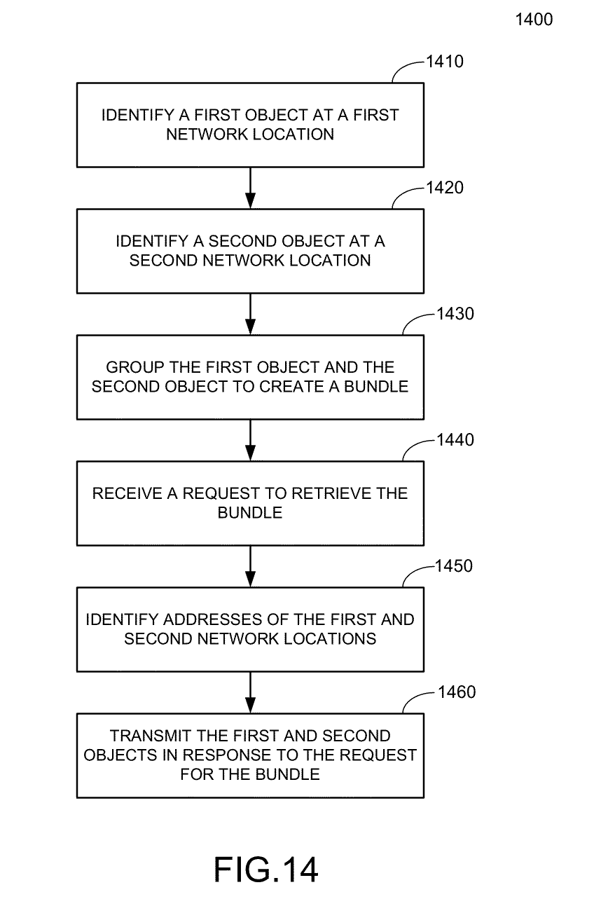

FIG. 14 is an example method 1400 to retrieve a bundle from one or more network locations in accordance with some embodiments. In general, the method 1400 may transmit a plurality of objects from one or more network locations in response to a request for a bundle from a user. In some embodiments, the method 1400 may be performed by a central management server and/or routing management device to retrieve files from network locations.

As shown in FIG. 14, at block 1410, a first object may be identified at a first network location. For example, a file may be identified at an online service such as social network, cloud storage service, etc. (as previously discussed). At block 1420, a second object may be identified at a second network location. For example, a file may be identified at a device storing the second file. In some embodiments, each of the first network location and the second network location may be at separate network addresses. In some embodiments, the first network location may be behind a local area network and the second network location may not be behind the local area network. In another embodiment, both the first network location and the second network location may be associated with one local area network. At block 1430, the first object and the second object may be grouped together to create a bundle. For example, the first object and the second object may be grouped into a bundle by a user from a graphical user interface (e.g., graphical user interface 1300). At block 1440, a request to retrieve the bundle may be received. For example, the central management server (e.g., central management server 1220) may receive the request from a remote user (e.g., remote user 1210). At block 1450, the addresses of the first and second network locations may be identified. For example, a network address on a wide area network (e.g., Internet) for each of the first and second network locations may be identified and/or received. For example, the network addresses may be stored on the central management server and/or routing management device. At block 1460, the first object and the second object may be transmitted to the user in response to the user requesting the bundle. In some embodiments, the transmission may be based on whether the requesting user has permission to access the first and second objects and/or the bundle.

In some embodiments, a network location may be a device (e.g., a storage device such as a hard drive) coupled to the routing management device. The central management server may determine an address location on a wide area network (e.g., Internet) for an object stored on the storage device, the storage device, or the routing management device. In some embodiments, such a determination of an object may comprise initiating a communication session over the wide area network from the routing management device to the central management device and then determining the address location of the object on the storage device based on the communication session. Such determination may be similar to the disclosure with relation to FIGS. 1, 3, and 4.

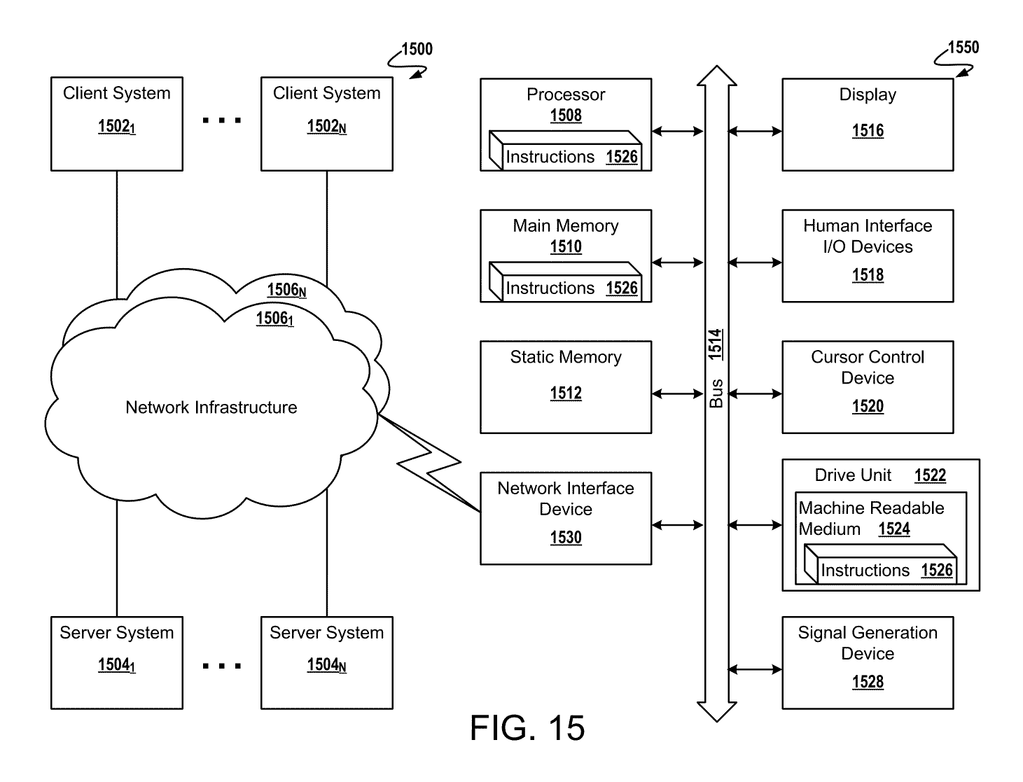

FIG. 15 is a diagrammatic representation of a network 1500, including nodes for client computer systems 1502₁ through 1502_{N}, nodes for server computer systems 1504₁ through 1504_{N}, nodes for network infrastructure 1506₁ through 1506_{N}, any of which nodes may comprise a machine 1550 within which a set of instructions for causing the machine to perform any one of the techniques discussed above may be executed. The embodiment shown is purely exemplary, and might be implemented in the context of one or more of the figures herein.

Any node of the network 1500 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1550 includes a processor 1508 (e.g. a processor core, a microprocessor, a computing device, etc.), a main memory 1510 and a static memory 1512, which communicate with each other via a bus 1514. The machine 1550 may further include a display unit 1516 that may comprise a touch-screen, or a liquid crystal display (LCD), or a light emitting diode (LED) display, or a cathode ray tube (CRT). As shown, the computer system 1550 also includes a human input/output (I/O) device 1518 (e.g. a keyboard, an alphanumeric keypad, etc.), a pointing device 1520 (e.g. a mouse, a touch screen, etc), a drive unit 1522 (e.g. a disk drive unit, a CD/DVD drive, a tangible computer readable removable media drive, an SSD storage device, etc.), a signal generation device 1528 (e.g. a speaker, an audio output, etc.), and a network interface device 1530 (e.g. an Ethernet interface, a wired network interface, a wireless network interface, a propagated signal interface, etc.).

The drive unit 1522 includes a machine-readable medium 1524 on which is stored a set of instructions (i.e. software, firmware, middleware, etc.) 1526 embodying any one, or all, of the methodologies described above. The set of instructions 1526 is also shown to reside, completely or at least partially, within the main memory 1510 and/or within the processor 1508. The set of instructions 1526 may further be transmitted or received via the network interface device 1530 over the network bus 1514.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

As such, the central management server, routing management device, and/or service devices may comprise any of the devices or components as discussed with relation to FIG. 15. Thus, each of the central management server, routing management device, and service devices may comprise a computer, processor, and/or memory.

Although the present disclosure has been described in terms of specific exemplary embodiments, it will be appreciated that various modifications and alterations might be made by those skilled in the art without departing from the spirit and scope of the disclosure. The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the widest scope consistent with the principles and novel features disclosed herein.

What is claimed is:

1. A method for retrieving a plurality of objects, said method comprising:
storing at least one object at a first network location;
storing at least one object at a second network location, wherein the second location comprises a distinct network location, across a wide area network, from the first network location;
grouping the objects from the first and second network locations as a bundle;
transmitting, from a user device, over a wide area network, a request to retrieve the bundle;
receiving the request, at a central management server, to retrieve the bundle;
determining, at the central management server, an address location on the wide area network of each object in the bundle;
retrieving each object in the bundle including retrieving the object from the first network address and the object from the second network address; and
transmitting the objects to the user device.

2. The method as set forth in claim 1, wherein grouping the objects as a bundle comprises:
displaying a graphic user interface, on a computer, that displays icons of the objects;
receiving input, from the computer, to bundle at least two objects.

3. The method as set forth in claim 1, wherein grouping the objects as a bundle comprises:
displaying an interface, on a computer, comprising a query input that receives at least one parameter to locate at least two objects;
receiving the parameter from the computer;
locating at least two objects specified by the parameter; and
creating a bundle that comprises the at least two objects.

4. The method as set forth in claim 1, wherein grouping the objects as a bundle comprises:
exposing an application program interface (“API”);
receiving an identification in the API to at least two objects; and
creating a bundle that comprises the at least two objects.

5. The method as set forth in claim 1, further comprising receiving input to specify access control to one or more bundles to permit sharing the objects to third party users.

6. The method as set forth in claim 1, wherein the user device comprises a third party user device that does not own the content of the objects of the bundle.

7. The method as set forth in claim 6, further comprising:
determining if the third party user device is authorized to access the bundle; and
transmitting the objects to the third party user device if the third user device is authorized to access the bundle.

8. The method as set forth in claim 7, further comprises transmitting a link to the third party device to permit the third party device to access the bundle.

9. The method as set forth in claim 1, wherein storing at least one object at a first or second network locations comprising storing at least one object on a third party commercial service.

10. The method as set forth in claim 9, wherein the third party commercial service comprises a social media network.

11. The method as set forth in claim 9, wherein the third party commercial service comprises a cloud storage service.

12. The method as set forth in claim 9, wherein retrieving an object in the bundle comprises:
accessing the third party commercial service through an application program interface (“API”);
authenticating the user device with the third party commercial service; and
retrieving the object from the third party commercial service through the API.

13. The method as set forth in claim 1, wherein storing at least one object at a first or second network locations comprising storing at least one object on a computer.

14. The method as set forth in claim 1, wherein storing at least one object at a first or second network location comprises storing at least one object on a mobile device.

15. The method as set forth in claim 1, wherein:
storing at least one object at a first or second network location comprises coupling at least one storage device to a routing management device;
determining, at the central management server, an address location on the wide area network for an object stored on the storage device comprises:
initiating a communication session over the wide area network from the routing management device to the central management server; and
determining the address location of the object stored on the storage device based on the communication session.

16. The method as set forth in claim 1, wherein:
storing at least one object at a first or second network location comprises storing at least one object on a computing device;
determining, at the central management server, an address location on the wide area network for an object stored on the computing device comprises:
initiating a communication session over the wide area network from the computing device to the central management server; and
determining the address location of the object stored on the computing device based on the communication session.

17. The method as set forth in claim 16, wherein the computing device comprises at least one of a laptop computer, a desktop computer, a server or a mobile device.

18. A non-transitory computer readable medium carrying one or more instructions to retrieve a plurality of objects, wherein the one or more instructions, when executed by one or more processors, causes the one or more processors to perform the steps of:
storing at least one object at a first network location;
storing at least one object at a second network location, wherein the second location comprises a distinct network location, across a wide area network, from the first network location;
grouping the objects from the first and second network locations as a bundle;
receiving a request from a user device over a wide area network to retrieve the bundle at a central management server;
determining, at the central management server, an address location on the wide area network of each object in the bundle;
retrieving each object in the bundle including retrieving the object from the first network address and the object from the second network address; and
transmitting the objects to the user device.

19. The non-transitory computer readable medium as set forth in claim 18, wherein grouping the objects as a bundle comprises:
displaying a graphic user interface, on a computer, that displays icons of the objects;
receiving input, from the computer, to bundle at least two objects.

20. The non-transitory computer readable medium as set forth in claim 18, wherein grouping the objects as a bundle comprises:
displaying an interface, on a computer, comprising a query input that receives at least one parameter to locate at least two objects;
receiving the parameter from the computer;
locating at least two objects specified by the parameter; and
creating a bundle that comprises the at least two objects.

21. The non-transitory computer readable medium as set forth in claim 18, wherein grouping the objects as a bundle comprises:
exposing an application program interface (“API”);
receiving an identification in the API to at least two objects; and
creating a bundle that comprises the at least two objects.

22. The non-transitory computer readable medium as set forth in claim 18, wherein the steps further comprise receiving input to specify access control to one or more bundles to permit sharing the objects to third party users.

23. The non-transitory computer readable medium as set forth in claim 18, wherein the user device comprises a third party user device that does not own the content of the objects of the bundle.

24. The non-transitory computer readable medium as set forth in claim 23, further comprising the steps of:
determining if the third party user device is authorized to access the bundle; and
transmitting the objects to the third party user device if the third user device is authorized to access the bundle.

25. The non-transitory computer readable medium as set forth in claim 24, wherein the steps further comprise transmitting a link to the third party device to permit the third party device to access the bundle.

26. The non-transitory computer readable medium as set forth in claim 18, wherein storing at least one object at a first or second network location comprises storing at least one object on a third party commercial service.

27. The non-transitory computer readable medium as set forth in claim 26, wherein the third party commercial service comprises a social media network.

28. The non-transitory computer readable medium as set forth in claim 26, wherein the third party commercial service comprises a cloud storage service.

29. The non-transitory computer readable medium as set forth in claim 26, wherein retrieving an object in the bundle comprises:
accessing the third party commercial service through an application program interface (“API”);
authenticating the user device with the third party commercial service; and
retrieving the object from the third party commercial service through the API.

30. The non-transitory computer readable medium as set forth in claim 18, wherein storing at least one object at a first or second network locations comprises storing at least one object on a computer.

31. The non-transitory computer readable medium as set forth in claim 18, wherein storing at least one object at a first or second network location comprises storing at least one object on a mobile device.

32. The non-transitory computer readable medium as set forth in claim 18, wherein the steps further comprise:
storing at least one object at a first or second network location comprises coupling at least one storage device to a routing management device;
determining, at the central management server, an address location on the wide area network for an object stored on the storage device comprises:
initiating a communication session over the wide area network from the routing management device to the central management server; and
determining the address location of the object stored on the storage device based on the communication session.

33. The non-transitory computer readable medium as set forth in claim 18, wherein the steps further comprise:
storing at least one object at a first or second network location comprises storing at least one object on a computing device;
determining, at the central management server, an address location on the wide area network for an object stored on the computing device comprises:
initiating a communication session over the wide area network from the computing device to the central management server; and
determining the address location of the object stored on the computing device based on the communication session.

34. The non-transitory computer readable medium as set forth in claim 33, wherein the computing device comprises at least one of a laptop computer, a desktop computer, a server or a mobile device.

35. A system, comprising at least one processor and memory, for retrieving a plurality of objects, said system comprising:
a module to store at least one object at a first network location;
a module to store at least one object at a second network location, wherein the second location comprises a distinct network location, across a wide area network, from the first network location;
a module to group the objects from the first and second network locations as a bundle;
a module to transmit, from a user device, over a wide area network, a request to retrieve the bundle;
a module to receive the request, at a central management server, to retrieve the bundle;
a module to determine, at the central management server, an address location on the wide area network of each object in the bundle;
a module to retrieve each object in the bundle including retrieving the object from the first network address and the object from the second network address; and
a module to transmit the objects to the user device.
